(19) United States
(12) Patent Application Publication
(10) Pub. No.: US 2025/0245546 A1
(43) Pub. Date: Jul. 31, 2025

(54) MACHINE LEARNING ASSISTED WEIGHTED PROCESS FOR DERIVING PRODUCT OR SERVICE SOLUTION RECOMMENDATIONS CORRESPONDING TO MODIFICATION OF A CLOUD COMPUTING ENVIRONMENT

(71) Applicant: Dell Products, L.P., Round Rock, TX (US)

(72) Inventors: Neal Beard, Austin, TX (US); Pankaj Pande, CARLINGFORD (AU); Jerrold Cady, Georgetown, TX (US); Jeffrey Scott Vah, Round Rock, TX (US); Mohamed Sohail, Sheikh Zayed (EG)

(21) Appl. No.: 18/423,053

(22) Filed: Jan. 25, 2024

(51) Int. Cl. G06N 20/00

(52) U.S. Cl. CPC G06N 20/00

(57) ABSTRACT

A machine learning (ML) assisted weighted process for deriving product or service solution recommendations corresponding to modification of a cloud computing environment is presented herein. A system sends default survey questions directed to assess current capabilities of a group of functions corresponding to the cloud computing environment; receives respective default survey responses to the default survey questions; based on the respective default survey responses, assigns, via a data store, a capability level of a group of capability levels to each function of the group of functions; converts a group of assigned capability levels into a distinct capability signature that numerically represents a derived capability profile of the group of functions; and based on the derived capability profile, predicts, using an ML process, follow-up survey questions that are directed to further assess additional functional capabilities of the group of functions, or alternate functional capabilities of a different group of functions.

### TECHNICAL FIELD

The subject disclosure generally relates to embodiments for a machine learning (ML) assisted weighted process for deriving product or service solution recommendations corresponding to modification of a cloud computing environment.

### BACKGROUND

Conventional cloud-based technologies rely on high availability features regarding, e.g., data storage, compute server, and/or database applications. Insufficient bandwidth (e.g., at a “network edge”) and erroneous configuration of mission-critical applications, e.g., resulting from incorrect data storage array provisioning, inappropriate security measures, and other misconfigurations related to such applications negatively affect cloud-based operations and customer experiences.

In this regard, conventional techniques that rely on manual data collection and data discovery to perform customer assessments of the high availability features utilize resource-intensive questionnaires that invariably induce respondent fatigue and disengagement (e.g., as customer's wade through redundant, perceived unnecessary, and/or low-value questions)—resulting in a lack of responsiveness and adaptability that further limits an efficacy and efficiency of customer assessments. Further, such conventional techniques incur extended data gathering periods (e.g., 3-4 months), inefficient allocation of customer resources, and an increased risk of misconfiguration of the cloud-based operations.

### BRIEF DESCRIPTION OF THE DRAWINGS

Non-limiting embodiments of the subject disclosure are described with reference to the following Figures, in which like reference numerals refer to like parts throughout the various views unless otherwise specified:

FIG. 1 illustrates a block diagram of a cloud computing environment and infrastructure including a cloud computing product/service solution recommendation system that adaptively, utilizing ML process(es), e.g., utilizing ML model(s), predicts and presents customer surveys to assess capabilities, weaknesses, and opportunities for improvement of the cloud computing environment and infrastructure, in accordance with various example embodiments;

FIG. 2 illustrates a block diagram of a cloud computing product/service solution recommendation system that adaptively, utilizing ML process(es), e.g., utilizing ML model(s), predicts and presents customer surveys to assess capabilities, weaknesses, and opportunities for improvement of the cloud computing environment and infrastructure, in accordance with various example embodiments;

FIG. 3 illustrates another block diagram of a cloud computing product/service solution recommendation system that adaptively, utilizing ML process(es), e.g., utilizing ML model(s), predicts and presents customer surveys to assess capabilities, weaknesses, and opportunities for improvement of the cloud computing environment and infrastructure, in accordance with various example embodiments;

FIG. 4 illustrates a block diagram of a process(es) utilized by a cloud computing product/service solution recommendation system that adaptively, utilizing ML process(es), e.g., utilizing ML model(s), predicts and presents customer surveys to assess capabilities, weaknesses, and opportunities for improvement of the cloud computing environment and infrastructure, in accordance with various example embodiments;

FIG. 5 illustrates a block diagram associated with a process performed by a capability signature and profile component that assigns, based on respective survey responses, a capability level of a group of capability levels to each function of a group of functions corresponding to a cloud computing environment and infrastructure of a client, in accordance with various example embodiments;

FIG. 6 illustrates a conversion, via a capability signature and profile component, of a group of assigned capability levels that have been assigned to a group of functions into a distinct capability signature that numerically represents a derived capability profile of the group of functions, in accordance with various example embodiments;

FIG. 7 illustrates a block diagram associated with a process performed by an ML survey question prediction and assessment component that predicts, based on a derived capability profile of a group of functions using an ML process, e.g., utilizing ML model(s), follow-up survey questions that are directed to further assess additional functional capabilities of the group of functions or alternate functional capabilities of a different group of functions, in accordance with various example embodiments;

FIG. 8 illustrates generation, based on respective follow-up survey responses via an ML survey question prediction and assessment component, of a distinct capability signature that numerically represents an updated derived capability profile of a group of functions and/or a different group of functions, in accordance with various example embodiments;

FIG. 9 illustrates a block diagram associated with a process performed by an ML survey question prediction and assessment component that generates, based on an updated derived capability profile, a summarized output representing a capability of a cloud computing environment and infrastructure, a determined risk impeding a performance of the cloud computing environment and infrastructure, and/or a suggested change of the cloud computing environment and infrastructure to facilitate an optimization the cloud computing environment and infrastructure, in accordance with various example embodiments;

FIG. 10 illustrates a block diagram of a cloud computing product/service solution recommendation system comprising an interface component and a free-form text processing component, in accordance with various example embodiments;

FIGS. 11-13 illustrate flow charts of a method associated with a cloud computing product/service solution recommendation system that adaptively, utilizing ML process(es), e.g., utilizing ML model(s), predicts and presents customer surveys to assess capabilities, weaknesses, and opportunities for improvement of the cloud computing environment and infrastructure, in accordance with various example embodiments;

FIGS. 14-15 illustrate flow charts of another method associated with a cloud computing product/service solution recommendation system that adaptively, utilizing ML process(es), e.g., utilizing ML model(s), predicts and presents customer surveys to assess capabilities, weaknesses, and opportunities for improvement of the cloud computing environment and infrastructure, in accordance with various example embodiments;

FIG. 16 illustrates a flow chart of a method associated with a cloud computing product/service solution recommendation system for performing free-form text processing, in accordance with various example embodiments; and

FIG. 17 illustrates a block diagram representing an illustrative non-limiting computing system or operating environment in which one or more aspects of various embodiments described herein can be implemented.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

As described above, conventional cloud-based technology assessments, e.g., regarding high availability features of such technologies, induce respondent fatigue and disengagement that results in a lack of responsiveness, an increased risk of misconfiguration, and inefficient allocation of customer resources. In various embodiments described herein, a cloud computing product/service solution recommendation system adaptively, via ML process(es), predicts and presents customer surveys to assess capabilities, weaknesses, and opportunities for improvement of a cloud computing environment and infrastructure.

For example, in embodiment(s), a system, e.g., a cloud computing product/service solution recommendation system, comprises a processor; and a memory that stores executable components that, when executed by the processor, facilitate performance of operations by the system, the operations comprising: sending, via a client interface, default survey questions directed to a client, in which the default survey questions are directed to assess current capabilities of respective functions of a group of functions corresponding to a cloud computing environment and infrastructure of the client; receiving, via the client interface, respective default survey responses to the default survey questions; based on the respective default survey responses, assigning, via a data store, a capability level of a group of capability levels to each function of the group of functions; converting a group of assigned capability levels that have been assigned to the group of functions into a distinct capability signature that numerically represents a derived capability profile of the group of functions, in which the group of assigned capability levels comprises the capability level; and based on the derived capability profile, predicting, using a machine learning process, follow-up survey questions that are directed to further assess additional functional capabilities of the group of functions or alternate functional capabilities of a different group of functions that is different from the group of functions.

In other embodiment(s), the distinct capability signature is a first distinct capability signature, and the operations further comprise: sending, via the client interface, the follow-up survey questions directed to the client; receiving, via the client interface, respective follow-up survey responses to the follow-up survey questions; and based on the respective follow-up survey responses and the first distinct capability signature, generating a second distinct capability signature that numerically represents an updated derived capability profile of the group of functions and/or the different group of functions;

Further, the operations comprise: based on the updated derived capability profile, generating a summarized output comprising a determined capability of the group of functions, a determined capability of the different group of functions, a determined risk impeding a performance of the group of functions, a determined risk impeding a performance of the different group of functions, and/or a suggested change corresponding to the cloud computing environment and infrastructure to facilitate an optimization of the group of functions or the different group of functions; and sending, via the client interface, the summarized output directed to the client.

In yet other embodiment(s), a method comprises: sending, by a system comprising at least one processor via a customer interface, initial survey questions that are directed to assess present capabilities of a group of functions corresponding to operation of a cloud computing environment and infrastructure; based on respective initial survey responses to the initial survey questions that have been received via the customer interface, assigning, by the system, a distinct capability level of a defined number of distinct capability levels to each function of the group of functions; converting, by the system, a group of distinct capability levels that have been assigned to the group of functions into a distinct signature comprising a defined numerical base, in which the distinct signature represents a derived capability profile representing functional capabilities of the group of functions, and in which the group of distinct capability levels comprises the distinct capability level; and based on the derived capability profile, predicting, by the system via an ML process, follow-up survey questions that are directed to further assess the functional capabilities of the group of functions or other functional capabilities that are different from the functional capabilities of the group of functions

In embodiment(s), the method further comprises: in response to sending the follow-up survey questions directed to a customer via the customer interface, receiving, by the system via the customer interface, respective follow-up survey responses to the follow-up survey questions; based on the respective follow-up survey responses, generating, by the system, a modified distinct signature that is different from the distinct signature and that represents an updated derived capability profile representing the functional capabilities of the group of functions and/or the other functional capabilities that are different from the functional capabilities of the group of functions; based on the updated derived capability profile, generating, by the system, a summarized output that identifies a capability of the cloud computing environment and infrastructure, a determined risk impeding a performance of the cloud computing environment and infrastructure, and/or a suggested change corresponding to the cloud computing environment and infrastructure to facilitate an optimization the cloud computing environment and infrastructure; and sending, by the system via the customer interface, the summarized output directed to the customer.

In other embodiment(s), a non-transitory machine-readable medium comprises instructions that, in response to execution, cause a system comprising at least one processor to perform operations, the operations comprising: in response to sending default survey questions directed to a user device for assessment of current capabilities of respective functions of a group of functions corresponding to a cloud computing environment and infrastructure of the user device, receiving respective default survey responses to the default survey questions; and based on the respective default survey responses, assigning a capability level of a group of capability levels to each function of the group of functions, converting a group of assigned capability levels—comprising the capability level—that have been assigned to the group of functions into a distinct signature that represents a derived capability profile of the group of functions, and based on the derived capability profile, predicting, via an ML process, follow-up survey questions that are directed to further assess additional functional capabilities of the group of functions or alternate functional capabilities of a different group of functions that is different from the group of functions.

In yet other embodiments, the distinct signature is a first distinct signature, and the operations further comprise: in response to sending the follow-up survey questions directed to the user device, receiving respective follow-up survey responses to the follow-up survey questions; based on the respective follow-up survey responses, generating a second distinct signature that numerically represents an updated derived capability profile of the group of functions and/or the different group of functions, based on the updated derived capability profile, generating an output comprising a summary of a capability of the cloud computing environment and infrastructure, a determined risk impeding a performance of the cloud computing environment and infrastructure, and/or a suggested change corresponding to the cloud computing environment and infrastructure to facilitate an optimization the cloud computing environment and infrastructure; and sending the output directed to the user device.

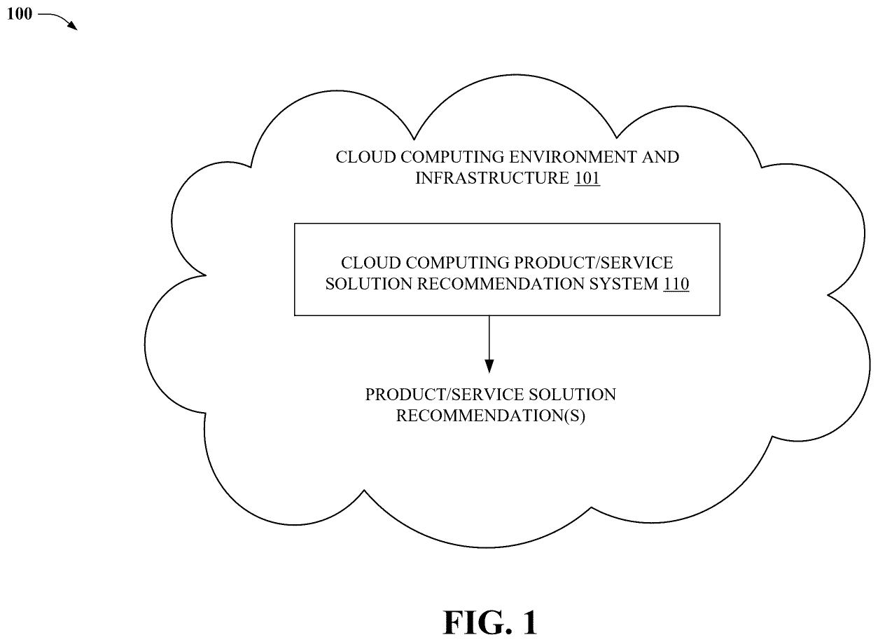

Now referring to FIGS. 1-4, a block diagram (100) of a cloud computing environment and infrastructure (101) including a cloud computing product/service solution recommendation system (110) that adaptively, utilizing ML process(es), predicts and presents customer surveys to assess capabilities, weaknesses, and opportunities for improvement of the cloud computing environment and infrastructure; block diagrams (200, 300) of the cloud computing product/service solution recommendation system; and a block diagram (400) of process(es) utilized by the cloud computing product/service solution recommendation system are illustrated, in accordance with various example embodiments.

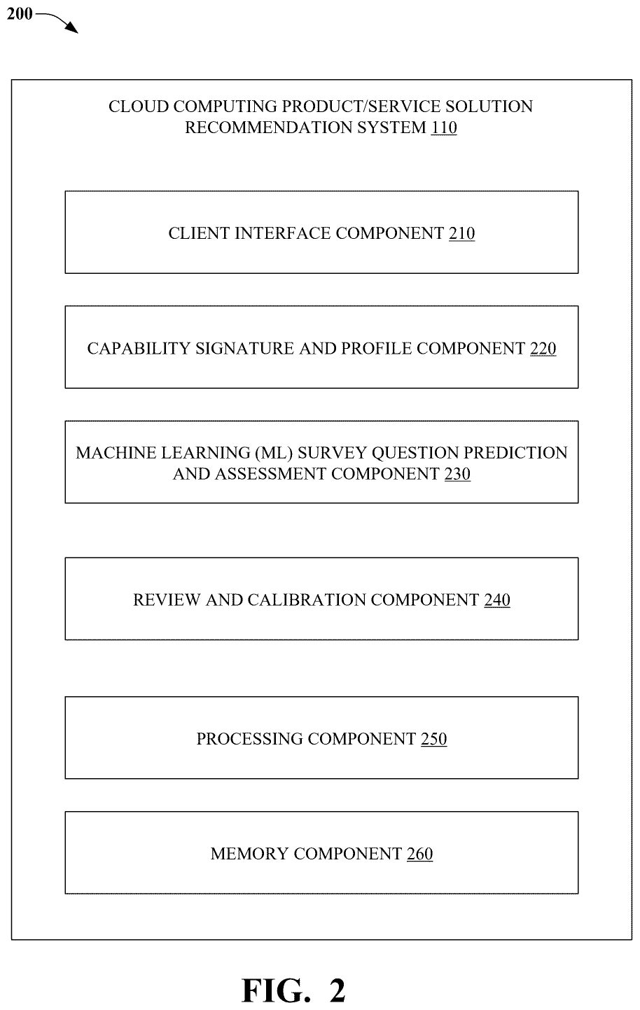

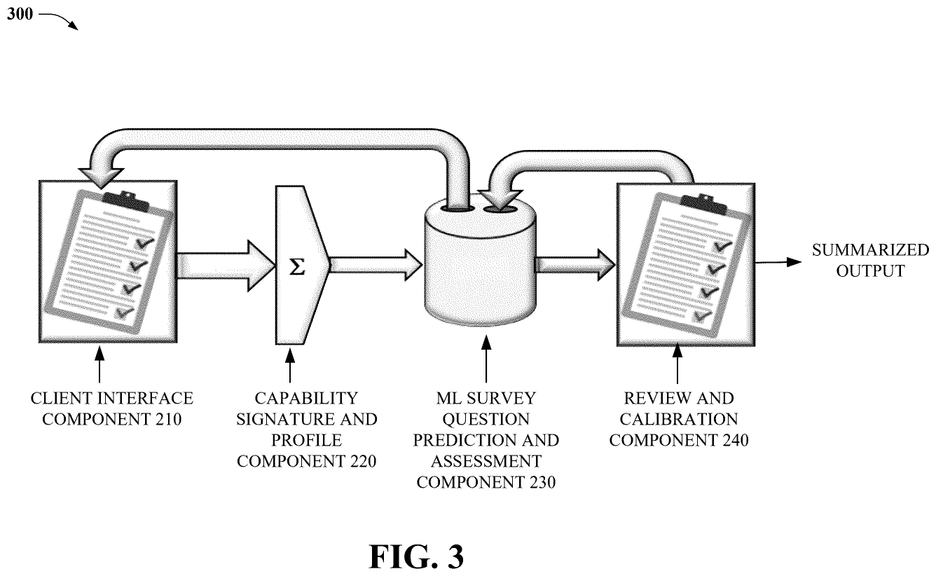

As illustrated by FIGS. 2 and 3, the cloud computing environment and infrastructure comprises, for example, a storage network, a computing network, a cloud-based network, a cloud computing environment, a data center, an on-premises-based network, or similar computing-based environment and/or infrastructure that utilizes high availability features corresponding to, e.g., data storage, compute server, and/or database applications.

The cloud computing product/service solution recommendation system includes a client interface component (210), a capability signature and profile component (220), an ML survey question prediction and assessment component (230), a review and calibration component (240), a processing component (250), and a memory component (260). In embodiment(s), the memory component stores executable instructions that, when executed by the processing component, facilitate performance of operations performed by the cloud computing product/service solution recommendation system, e.g., via the above listed components of the cloud computing product/service solution recommendation system.

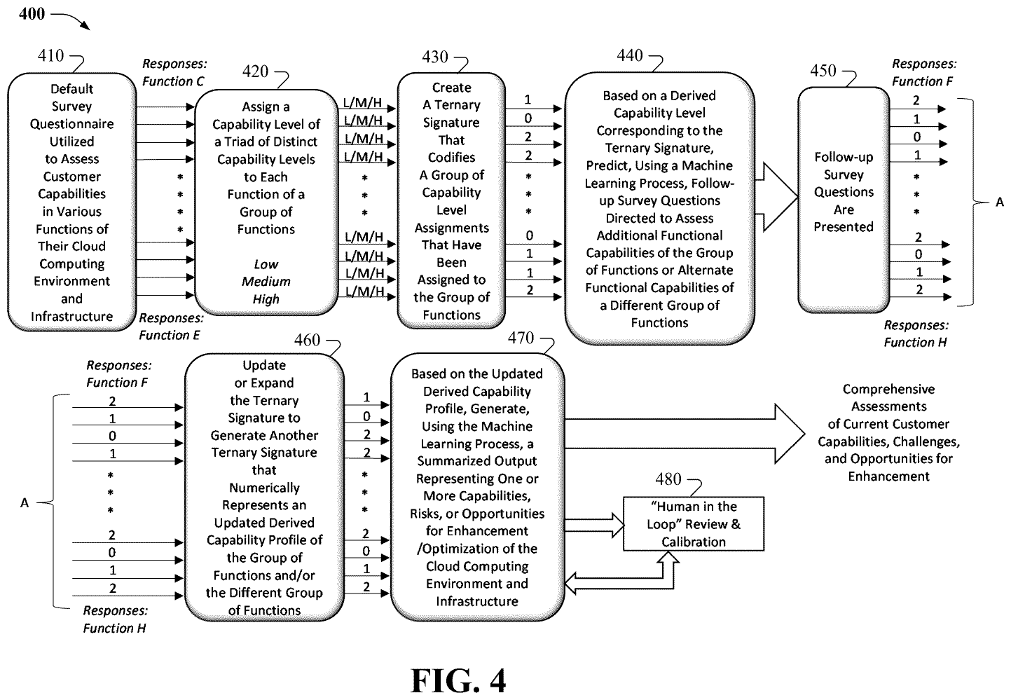

In embodiment(s), and now referring to FIG. 4, the cloud computing product/service solution recommendation system sends, via a client interface (e.g., via client interface component 210), default survey questions directed to a client, in which the default survey questions are directed to assess current capabilities of respective functions of a group of functions corresponding to the cloud computing environment and infrastructure (see, e.g., 410).

In various embodiment(s), the group of functions comprises an array of functional capabilities corresponding to an operation of the cloud computing environment, a security of the cloud computing environment, and a performance optimization of the cloud computing environment. Further, the functional capabilities comprise data management functions, data security functions, resource allocation functions, and service continuity functions.

In turn, the capability signature and profile component receives, via the client interface, respective default survey responses to the default survey questions, and based on the respective default survey responses, assigns, via a data store (e.g., data table 610 described below), a capability level of a group of capability levels to each function of the group of functions (see, e.g., 420).

In this regard, in embodiment(s), the capability signature and profile component assigns a capability level to each function by determining a sum of respective scores of a group of responses corresponding to a group of survey questions of the default survey questions that have been directed to assess capabilities of a function of the group of functions; and based on the sum being determined to correspond to the capability level, assigns the capability level to the function.

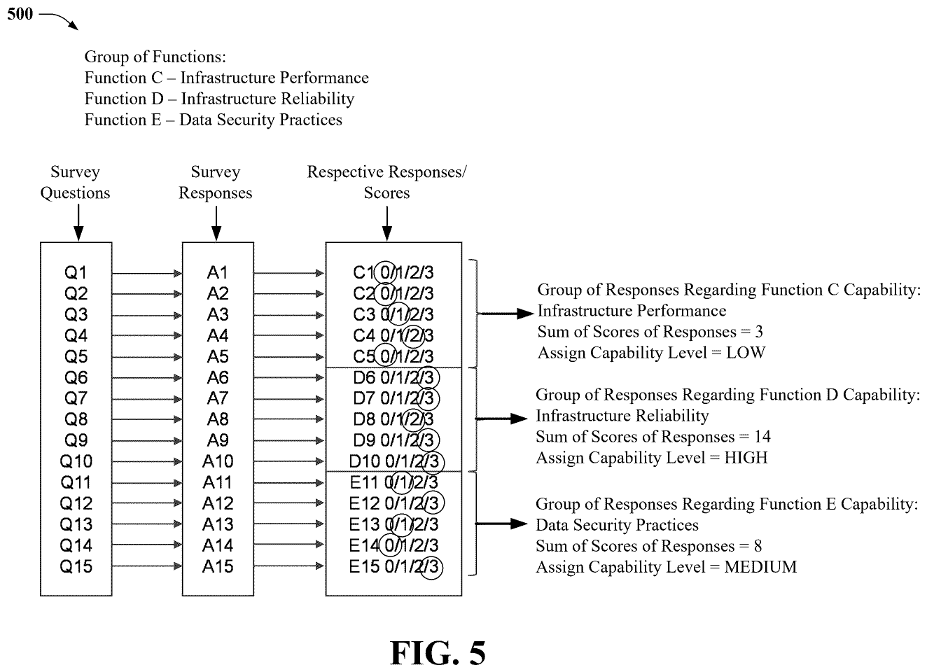

In embodiment(s) illustrated by FIG. 5, the group of functions includes functions corresponding to infrastructure performance, infrastructure reliability, and data security practices; five survey questions and corresponding survey responses correspond to each function; each survey question comprises four response choices/scores (e.g., 0 representing “skip question” or no capability, 1 representing good capability, 2 representing better capability, and 3 representing best capability); and the group of capability levels comprises a triad of distinct capability levels (e.g., “LOW”, “MEDIUM”, and “HIGH”), in which each distinct capability level of the triad of distinct capability levels corresponds to a defined range of the sum of the respective scores of the group of responses.

For example, a low capability level corresponds to a sum of scores of responses/answers to survey questions of a function being in the range of 0-5; a medium capability level corresponds to the sum of scores of responses/answers being in the range of 6-10; and a high capability level corresponds to the sum of scores of responses/answers being in the range of 11-15.

It should be appreciated by a person of ordinary skill in the art of data collection and discovery having the benefit of the present disclosure that in other embodiment(s), less than or more than five survey questions and corresponding survey responses can correspond to each question; each survey question can comprise less than or more than four response choices/scores; the group of capability levels can comprise less than or more than three distinct capability levels; and each capability level can correspond to various defined ranges of sums of scores of responses/answers.

Referring again to embodiment(s) illustrated by FIG. 5, the capability signature and profile component, based on sums of scores (e.g., 3, 14, and 8) of responses to respective functions (e.g., infrastructure performance, infrastructure reliability, and data security practices), assigns a low capability profile, or capability level, to the infrastructure performance function; a high capability profile, or capability level, to the infrastructure reliability function; and a medium capability profile, or capability level, to the data security practices function.

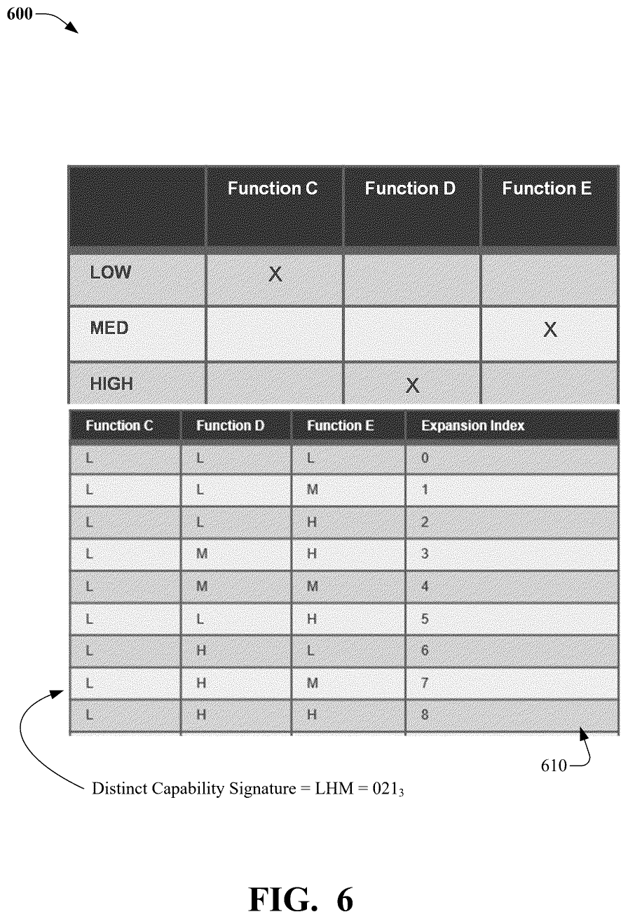

In turn, and now referring now to FIG. 6, the capability signature and profile component converts a group of assigned capability levels that have been assigned to the group of functions into a distinct capability signature that numerically represents a derived capability profile of the group of functions.

In embodiment(s), the derived capability profile represents a performance capability profile, a reliability capability profile, a data security capability profile, a cost management capability profile, an organizational capability profile, and/or an operational sustainability capability profile.

In other embodiment(s), based on historical training data comprising responses to a defined amount of survey questions (e.g., greater than 1,000) that have been directed to assess respective capabilities of the cloud computing environment and infrastructure, the capability signature and profile component converts (e.g., codifies), via ML process(es), e.g., utilizing ML model(s), the group of assigned capability levels into the distinct capability signature that numerically represents the derived capability profile of the group of functions.

In this regard, based on the historical training data, the capability signature and profile component, via the ML process(es), e.g., utilizing ML model(s), associates, via the data store (e.g., data table 610), the distinct capability signature with the derived capability profile—the derived capability profile representing a capability profile that requires information about the additional functional capabilities of the group of functions or the alternate functional capabilities of the different group of functions.

In embodiment(s), the capability signature and profile component generates the distinct capability signature based on a number of functions that have been included in the group of functions—the distinct capability signature comprising a defined number of digits of a defined mathematical radix (or base), in which the defined number of digits has been selected by the capability signature and profile component to equal the number of functions that have been included in the group of functions.

For example, in other embodiment(s), the capability signature and profile component converts (e.g., codifies), via ML process(es), e.g., utilizing ML model(s), a group of assigned capability levels (e.g., low, high, medium) that have been assigned to the group of functions (e.g., infrastructure performance, infrastructure reliability, and data security practices) into a distinct capability signature (e.g., LHM, or 021₃) that numerically represents a derived capability profile of the group of functions (see, e.g., 430).

Based on the derived capability profile of the group of functions, the ML survey question prediction and assessment component predicts, using an ML process, e.g., utilizing ML model(s), follow-up survey questions that are directed to further assess additional functional capabilities of the group of functions or alternate functional capabilities of a different group of functions (see, e.g., 440).

In embodiment(s), the ML survey question prediction and assessment component predicts the follow-up survey questions by selecting, using the data store, the derived capability profile based on the distinct capability signature; and based on the derived capability profile, the ML survey question prediction and assessment component selects the follow-up survey questions, e.g., referenced via the data store.

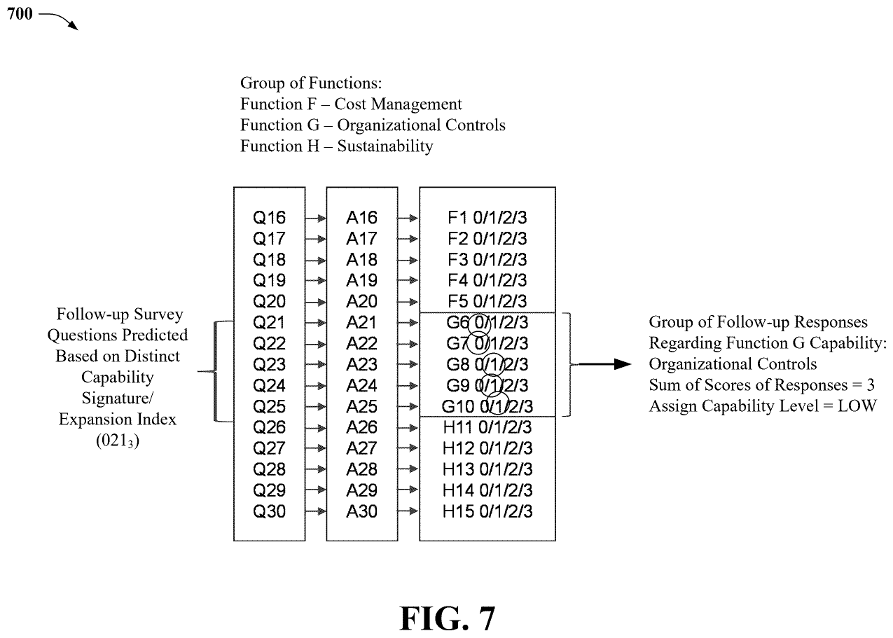

For example, in embodiment(s) illustrated by FIG. 7, the ML survey question prediction and assessment component predicts, based on the distinct capability signature (e.g., 021₃), a group of follow-up survey questions (e.g., Q21-Q25) that are directed to assess alternate functional capabilities, e.g., regarding organizational controls.

In turn, the cloud computing product/service solution recommendation system sends, via the client interface (e.g., via client interface component 210), the group of follow-up survey questions directed to the client to further assess the alternate functional capabilities regarding organizational controls (see, e.g., 450).

In response to receiving, via the client interface, a group of follow-up survey responses corresponding to the group of follow-up survey questions, the capability signature and profile component assigns, via the data store, a capability level of a group of capability levels to the alternate functional capabilities regarding organizational controls.

For example, in embodiment(s) illustrated by FIG. 7, based on a sum of scores (e.g., 3) of responses to the group of follow-up survey questions that were directed to assess alternate functional capabilities regarding organizational controls, the capability signature and profile component assigns a low capability profile, or capability level, to the organizational controls function.

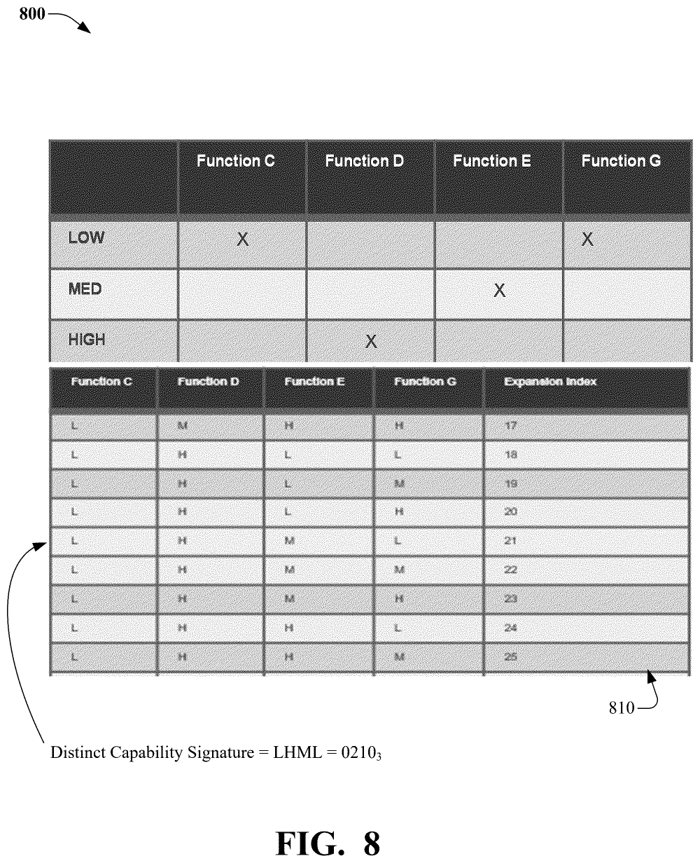

In turn, and now referring to FIG. 8, based on the low capability profile that was assigned to the functional capabilities regarding organizational controls, and the distinct capability signature (e.g., 021₃) that numerically represents the derived capability profile of the group of functions (e.g., infrastructure performance, infrastructure reliability, and data security practices), the capability signature and profile component generates, via ML process(es), e.g., utilizing ML model(s), a distinct capability signature (e.g., LHML, or 0210₃) that numerically represents an updated derived capability profile of the group of functions and/or the different group of functions (see, e.g., 460).

In embodiment(s), the updated derived capability profile represents a performance capability profile, a reliability capability profile, a data security capability profile, a cost management capability profile, an organizational capability profile, and/or an operational sustainability capability profile.

In other embodiment(s), the capability signature and profile component generates, via ML process(es), e.g., utilizing ML model(s), the distinct capability signature that numerically represents the updated derived capability profile based on historical training data comprising responses to a defined amount of survey questions (e.g., greater than 1,000) that have been directed to assess respective capabilities of the cloud computing environment and infrastructure, and/or comprising determined outcomes of recommendations that have been made via the cloud computing product/service solution recommendation system, e.g., to affect respective optimizations of the cloud computing environment and infrastructure.

In embodiment(s), the capability signature and profile component associates, via the data store (e.g., data table 810), the distinct capability signature with the updated derived capability profile.

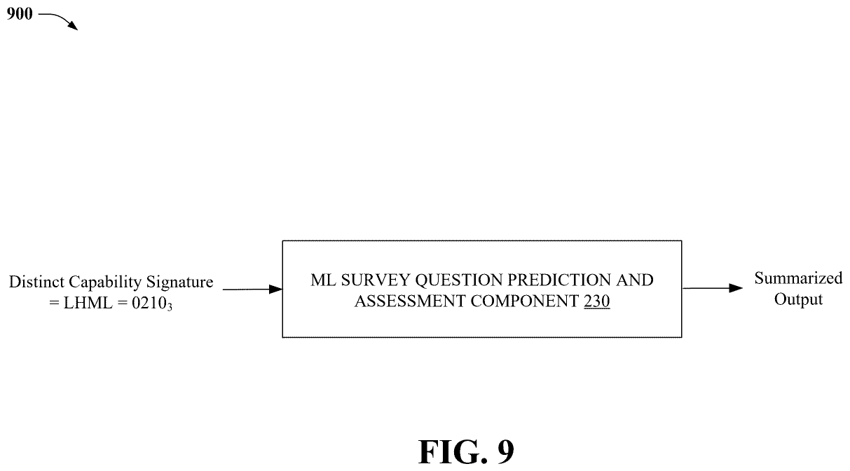

Referring now to FIG. 9, based on the distinct capability signature (e.g., LHML, or 0210₃) that numerically represents the updated derived capability profile, the ML survey question prediction and assessment component generates, via ML process(es), e.g., utilizing ML model(s), a summarized output comprising a determined capability of the group of functions, a determined capability of the different group of functions, a determined risk impeding a performance of the group of functions, a determined risk impeding a performance of the different group of functions, and/or a suggested change corresponding to the cloud computing environment and infrastructure to facilitate an optimization of the group of functions or the different group of functions (see, e.g., 470).

In embodiment(s), the updated derived capability profile specifies, via the data store, the summarized output. In turn, based on the distinct capability signature numerically representing the updated derived capability profile, the ML survey question prediction and assessment component selects, using the data store, the updated derived capability profile; and based on the updated derived capability profile, the ML survey question prediction and assessment component selects the summarized output and sends, via the client interface, the summarized output directed to the client.

In embodiment(s), the capability signature and profile component and the ML survey question prediction and assessment component perform operations utilizing ML model(s) (e.g., a decision tree-based learning model, a linear regression-based learning model, and/or a Bayesian based learning model) corresponding to respective ML processes to optimize, e.g., via a feedback loop, such operations.

In this regard, the capability signature and profile component and the ML survey question prediction and assessment component can utilize various support vector machines that can be configured, based on historical training data via a learning or training phase utilizing classifier(s), to automatically learn and perform a number of functions, e.g., performed by the cloud computing product service solution recommendation system.

An example classifier can be a function that maps an input attribute vector, x=(x1, x2, x3, x4, xn) (e.g., a distinct capability signature numerically representing a derived capability profile of a group of functions) to a confidence that the input belongs to a class (e.g., f(x)=confidence (class)), for example, that the input attribute vector representing the derived capability profile of the group of functions satisfies a defined condition with respect to predicting follow-up survey questions that are directed to further assess additional functional capabilities of the group of functions, or alternate functional capabilities of a different group of functions that is different from the group of functions.

Such classification can employ a probabilistic and/or a statistical-based analysis (e.g., factoring into the analysis utilities and costs) to prognose or infer an action that can be automatically performed, e.g., associating, via a data store, the distinct capability signature with a derived capability profile representing a capability profile that requires information about additional functional capabilities of a group of functions or alternate functional capabilities of a different group of functions.

A support vector machine (SVM) is an example of a classifier that can be employed. The SVM can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence. Classification as used herein also may be inclusive of statistical regression that is utilized to develop models of priority.

The disclosed aspects can employ classifiers that are explicitly trained (e.g., via a generic training data) as well as implicitly trained (e.g., based on historical training data) with respect to triggering events and/or observing whether respective task performances satisfy corresponding defined conditions (e.g., whether the respective task performances satisfy defined conditions representing a determined capability of the group of functions and/or the different group of functions; a determined risk impeding a performance of the group of functions and/or the different group of functions; and/or a suggested change corresponding to the cloud computing environment and infrastructure to facilitate an optimization of the group of functions or the different group of functions). For example, SVMs can be configured via a learning or training phase via the ML survey question prediction and assessment component.

In embodiment(s), the ML survey question prediction and assessment component maps/associates, via a data store using metadata, the determined capability of the group of functions and/or the different group of functions to corresponding determined outcomes of recommendations that have been made via the cloud computing product/service solution recommendation system, e.g., to affect respective optimizations of the cloud computing environment and infrastructure.

In one embodiment, the determined outcomes of the recommendations correspond to and/or represent an updated derived capability profile of the group of functions and/or the different group of functions.

In yet another embodiment, the determined outcomes of the recommendations correspond to and/or represent follow-up survey questions that are directed to further assess additional functional capabilities of the group of functions or alternate functional capabilities of the different group of functions.

In another embodiment, the updated derived capability profile represents a summarized output that corresponds to the determined outcomes of the recommendations.

In this regard, in embodiment(s), the ML survey question prediction and assessment component can train, refine, and/or generate respective classifier(s) and/or SVMs Thus, the classifier(s) can be used, via the ML survey question prediction and assessment component, to automatically learn and perform a number of functions and/or predict and/or anticipate event(s)/condition(s) including, but not limited to: converting a group of assigned capability levels that have been assigned to a group of functions into a distinct capability signature that numerically represents a derived capability profile of the group of functions; predicting follow-up survey questions; generating a distinct capability signature that numerically represents an updated derived capability profile of the group of functions and/or the different group of functions based on respective follow-up survey responses and a previously derived distinct capability signature; and generating a summarized output based on the updated derived capability profile.

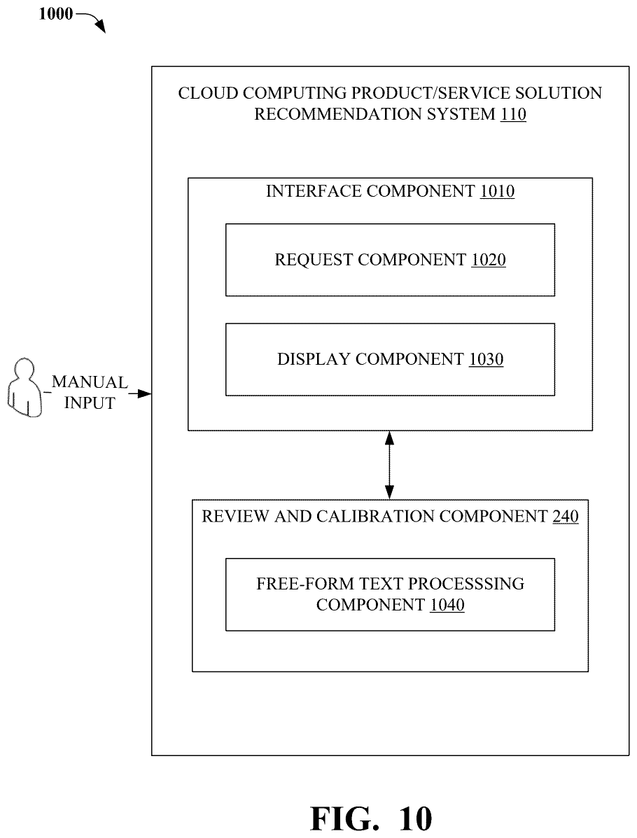

FIG. 10 illustrates a block diagram of a cloud computing product/service solution recommendation system comprising an interface component (1010) and a free-form text processing component (1040), in accordance with various example embodiments. The interface component provides a “human in the loop” interface to facilitate, e.g., via a review and calibration component (240), monitoring, recalibration, and managing of process(es) performed via the cloud computing product/service solution recommendation system (see, e.g., 480). In this regard, the interface component enables the user to view and modify information and/or parameters associated with operations being performed by the cloud computing product/service solution recommendation system.

In embodiment(s), the interface component receives, from the user via a request component 1020, a request, e.g., manual input, to perform an action. In embodiment(s), the action includes displaying, via display component 1030, and/or modifying, via the review and calibration component, at least a portion of the information and/or parameters associated with operations being performed by the cloud computing product/service solution recommendation system.

For example, portion(s) of the information and/or parameters comprise at least one of: information represented vis the data store (e.g., data table 610, data table 810); a derived capability profile of the group of functions; an updated capability profile of the group of functions and/or the different group of functions; a number of functions, and types of functions, to be included in the group of functions and/or the different group of functions; a defined mathematical radix (or base) of a distinct capability signature; a number of survey questions corresponding each function; a number of survey response choices and/or corresponding scores corresponding to each survey question; a number of distinct capability levels of the group of capability levels; defined ranges of sums of scores of responses/answers to survey questions corresponding to each capability level; a defined amount of survey questions to be included in the historical training data; and/or determined outcomes of recommendations that have been made via the cloud computing product/service solution recommendation system.

In other embodiment(s), based on the portion(s) of the information and/or parameters associated with operations being performed by the cloud computing product/service solution recommendation system, the user, via the interface component, can recalibrate the ML process(es) being performed via the ML survey question prediction and assessment component.

For example, in response to determining that the ML survey question prediction and assessment component is operating outside of defined conditions (e.g., representing that survey questions corresponding to respective groups of functions were not presented and/or evaluated by the ML survey question prediction and assessment component), the user can initiate consideration, via the ML survey question prediction and assessment component, of different historical data.

In various embodiment(s), respective portions of the initial survey questions or the follow-up survey questions comprise respective free-form text fields. In this regard, the review and calibration component, via the free-form text processing component, converts, utilizing natural language processing via an ML process, the respective free-form text fields into a text output comprising respective keywords representing content of the free-form text fields.

In embodiment(s), the text output can represent answers/responses that have been written, by a customer/client, in the free-form text field, e.g., representing comments corresponding to survey questions and/or other information that has not been selectable as answer(s) via the survey responses.

In turn, based on the text output and the respective keywords, the review and calibration component generates at least one of the distinct signature or the modified distinct signature.

In embodiment(s), the review and calibration component can associate (e.g., via the data store), based on the distinct signature and/or the modified distinct signature, the respective keywords with respective functions of the group of functions or the different group of functions.

In other embodiment(s), the summarized output comprises at least portion of the free-form text and/or the respective keywords.

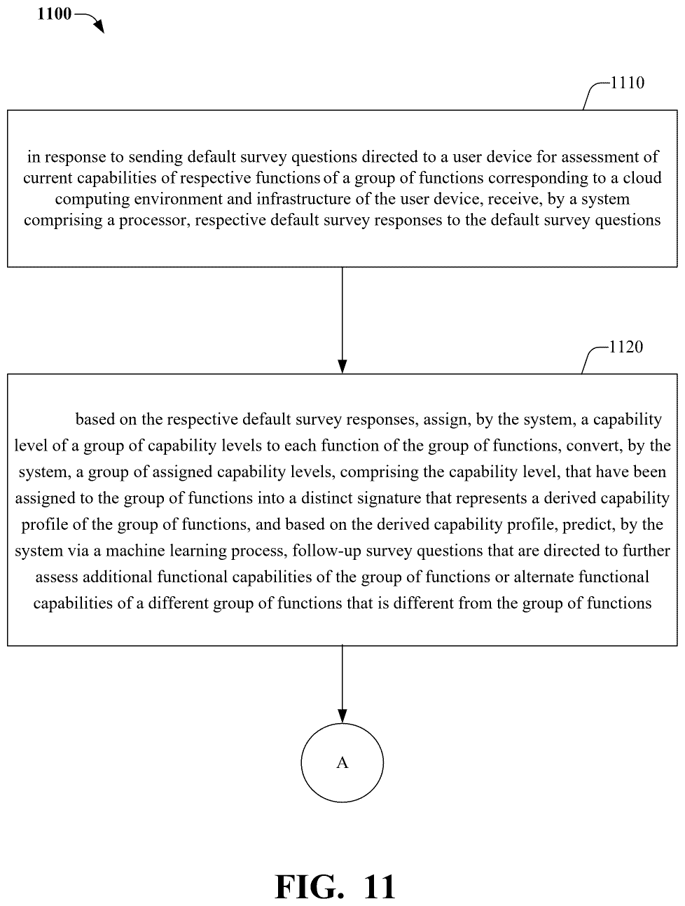

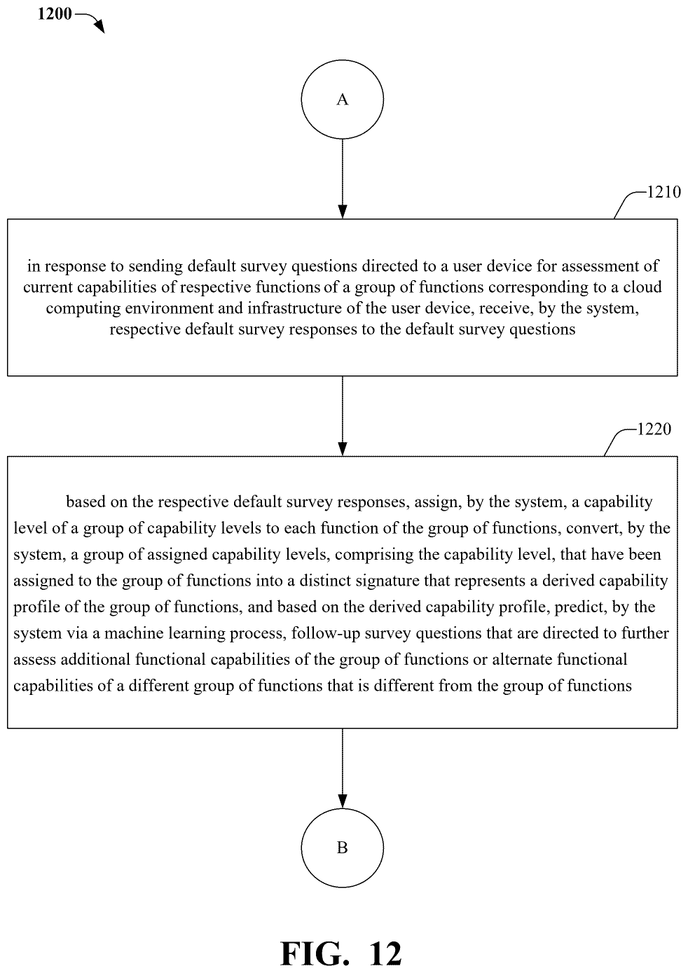

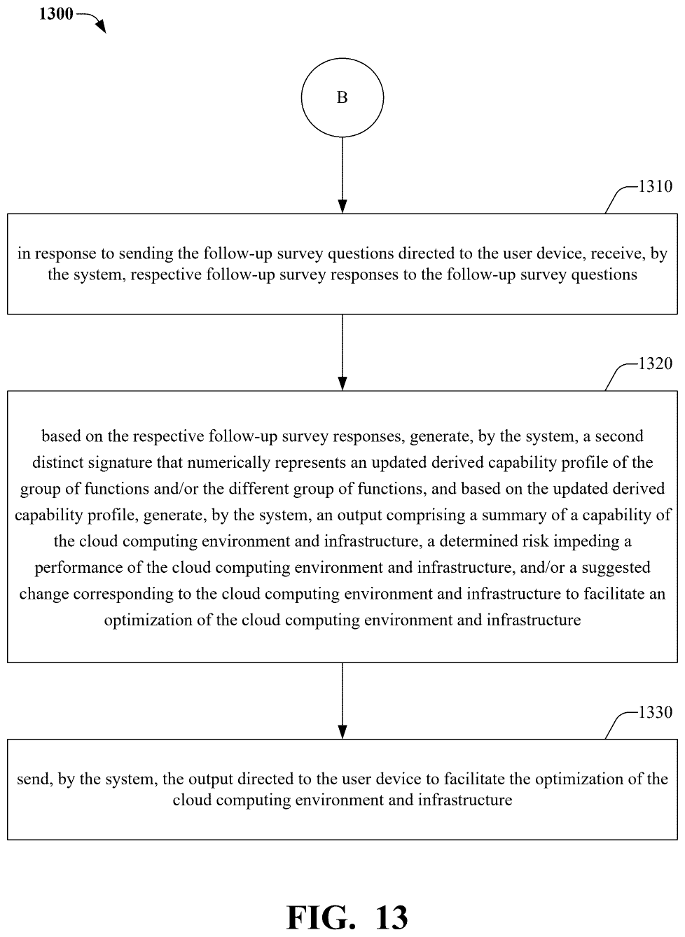

FIGS. 11-16 illustrate methodologies in accordance with the disclosed subject matter. For simplicity of explanation, the methodologies are depicted and described as a series of acts. It is to be understood and appreciated that various embodiments disclosed herein are not limited by the acts illustrated and/or by the order of acts. For example, acts can occur in various orders and/or concurrently, and with other acts not presented or described herein. Furthermore, not all illustrated acts may be required to implement the methodologies in accordance with the disclosed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIGS. 11-13 illustrate flow charts (1100-1300) of a method associated with a cloud computing product/service solution recommendation system (110) that adaptively, utilizing ML process(es), e.g., utilizing ML model(s), predicts and presents customer surveys to assess capabilities, weaknesses, and opportunities for improvement of a cloud computing environment and infrastructure (101), in accordance with various example embodiments.

At 1110, a system (110), in response to sending default survey questions directed to a user device for assessment of current capabilities of respective functions of a group of functions corresponding to a cloud computing environment and infrastructure of the user device, receives respective default survey responses to the default survey questions.

At 1120, based on the respective default survey responses, the system assigns a capability level of a group of capability levels to each function of the group of functions; converts a group of assigned capability levels-comprising the capability level—that have been assigned to the group of functions into a distinct signature that represents a derived capability profile of the group of functions; and based on the derived capability profile, predicts, via an ML process, e.g., utilizing ML model(s), follow-up survey questions that are directed to further assess additional functional capabilities of the group of functions or alternate functional capabilities of a different group of functions that is different from the group of functions.

At 1210, in response to sending default survey questions directed to a user device for assessment of current capabilities of respective functions of a group of functions corresponding to a cloud computing environment and infrastructure of the user device, the system receives respective default survey responses to the default survey questions.

At 1220, based on the respective default survey responses, the system assigns a capability level of a group of capability levels to each function of the group of functions; converts a group of assigned capability levels-comprising the capability level—that have been assigned to the group of functions into a distinct signature (e.g., first distinct signature) that represents a derived capability profile of the group of functions; and based on the derived capability profile, predicts, via an ML process, e.g., utilizing ML model(s), follow-up survey questions that are directed to further assess additional functional capabilities of the group of functions or alternate functional capabilities of a different group of functions that is different from the group of functions.

At 1310, in response to sending the follow-up survey questions directed to the user device, the system receives respective follow-up survey responses to the follow-up survey questions. At 1320, based on the respective follow-up survey responses, the system generates a second distinct signature that numerically represents an updated derived capability profile of the group of functions and/or the different group of functions; and based on the updated derived capability profile, generates an output comprising a summary of a capability of the cloud computing environment and infrastructure, a determined risk impeding a performance of the cloud computing environment and infrastructure, and/or a suggested change corresponding to the cloud computing environment and infrastructure to facilitate an optimization of the cloud computing environment and infrastructure

At 1330, the system sends the output directed to the user device to facilitate the optimization of the cloud computing environment and infrastructure.

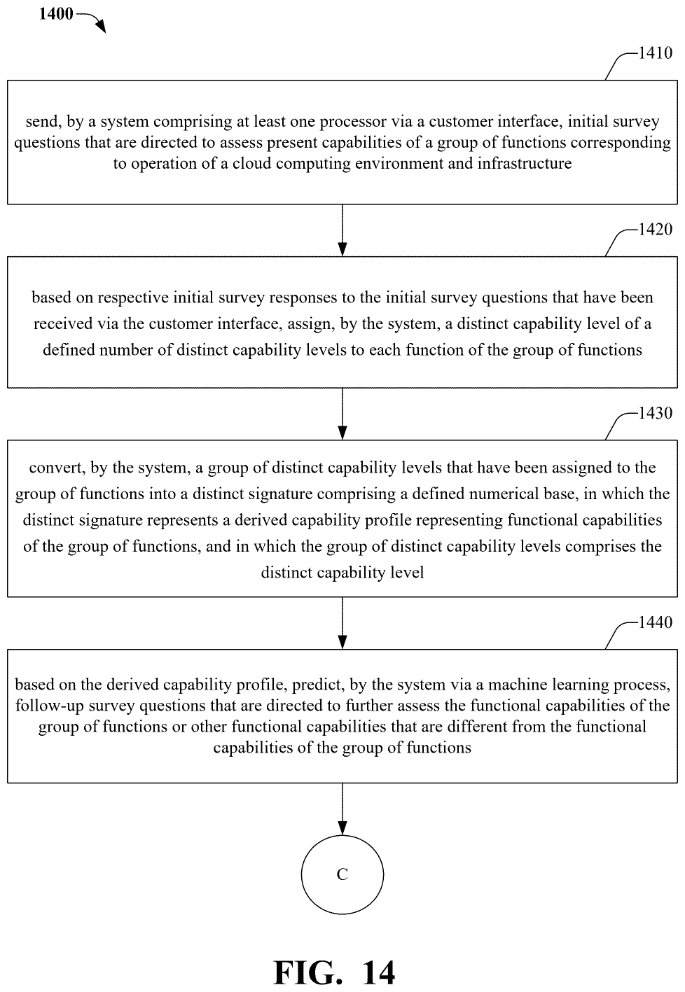

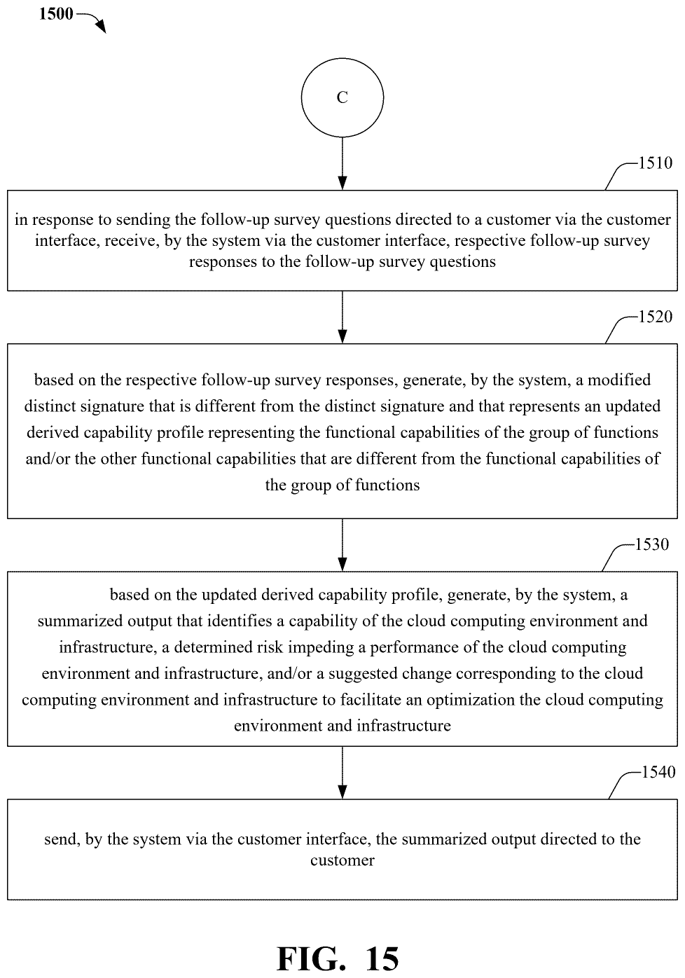

FIGS. 14-15 illustrate flow charts (1400-1500) of another method associated with a cloud computing product/service solution recommendation system (110) that adaptively, utilizing ML process(es), e.g., utilizing ML model(s), predicts and presents customer surveys to assess capabilities, weaknesses, and opportunities for improvement of the cloud computing environment and infrastructure, in accordance with various example embodiments

At 1410, the system sends, via a customer interface, initial survey questions that are directed to assess present capabilities of a group of functions corresponding to operation of a cloud computing environment and infrastructure.

At 1420, based on respective initial survey responses to the initial survey questions that have been received via the customer interface, the system assigns a distinct capability level of a defined number of distinct capability levels to each function of the group of functions.

At 1430, the system converts a group of distinct capability levels that have been assigned to the group of functions into a distinct signature comprising a defined numerical base, in which the distinct signature represents a derived capability profile representing functional capabilities of the group of functions, and in which the group of distinct capability levels comprises the distinct capability level.

At 1440, based on the derived capability profile, the system predicts, via an ML process, e.g., utilizing ML model(s), follow-up survey questions that are directed to further assess the functional capabilities of the group of functions or other functional capabilities that are different from the functional capabilities of the group of functions.

At 1510, in response to sending the follow-up survey questions directed to a customer via the customer interface, the system receives, via the customer interface, respective follow-up survey responses to the follow-up survey questions.

At 1520, based on the respective follow-up survey responses, the system generates a modified distinct signature that is different from the distinct signature and that represents an updated derived capability profile representing the functional capabilities of the group of functions and/or the other functional capabilities that are different from the functional capabilities of the group of functions.

At 1530, based on the updated derived capability profile, the system generates a summarized output that identifies a capability of the cloud computing environment and infrastructure, a determined risk impeding a performance of the cloud computing environment and infrastructure, and/or a suggested change corresponding to the cloud computing environment and infrastructure to facilitate an optimization the cloud computing environment and infrastructure.

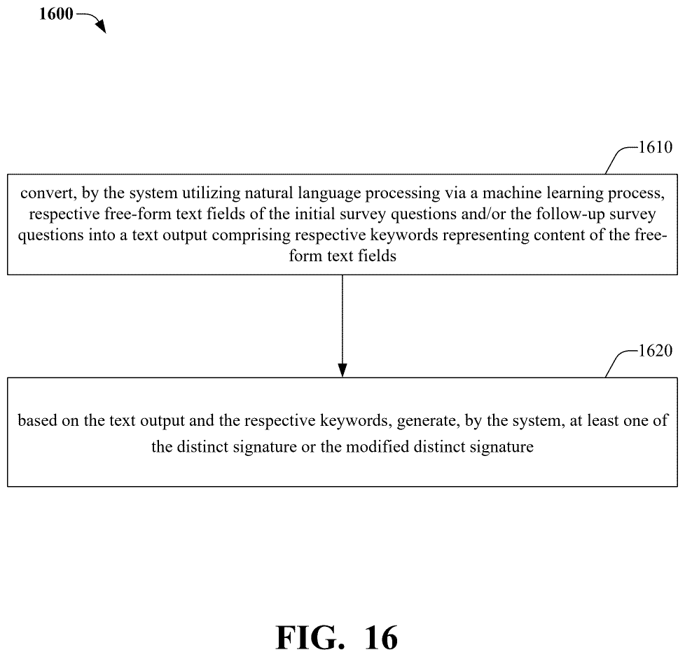

FIG. 16 illustrates a flow chart (1600) of a method associated with a cloud computing product/service solution recommendation system (110) for performing free-form text processing, in accordance with various example embodiments. At 1610, the system converts, utilizing natural language processing via an ML process, respective free-form text fields of the initial survey questions and/or the follow-up survey questions into a text output comprising respective keywords representing content of the free-form text fields.

At 1620, based on the text output and the respective keywords, the system generates the distinct signature and/or the modified distinct signature.

Reference throughout this specification to “one embodiment,” “an embodiment,” “another embodiment”, “yet another embodiment”, “embodiment(s)”, “other “embodiment(s)”, and “yet other embodiment(s)” means that a particular feature, structure, or characteristic described in connection with the embodiment is included in at least one embodiment. Thus, the appearances of the phrase “in one embodiment,” “in an embodiment,” “in another embodiment”, “in yet another embodiment”, “in embodiment(s)”, “in other embodiment(s)”, and “in yet other embodiment(s)” in various places throughout this specification are not necessarily all referring to the same embodiment. Furthermore, the particular features, structures, or characteristics may be combined in any suitable manner in one or more embodiments.

Furthermore, to the extent that the terms “includes,” “has,” “contains,” and other similar words are used in either the detailed description or the appended claims, such terms are intended to be inclusive—in a manner similar to the term “comprising” as an open transition word-without precluding any additional or other elements. Moreover, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As utilized herein, terms “component”, “system”, and the like are intended to refer to a computer-related entity, hardware, software (e.g., in execution), middleware, and/or firmware. For example, a component can be a processor, a process running on a processor, an object, an executable, a program, a storage device, and/or a computer. By way of illustration, an application running on a server, client, etc. and the server, client, etc. can be a component. One or more components can reside within a process, and a component can be localized on one computer and/or distributed between two or more computers.

Further, components can execute from various computer readable media having various data structures stored thereon. The components can communicate via local and/or remote processes such as in accordance with a signal having one or more data packets (e.g., data from one component interacting with another component in a local system, distributed system, and/or across a network, e.g., the Internet, with other systems via the signal).

As another example, a component can be an apparatus with specific functionality provided by mechanical parts operated by electric or electronic circuitry; the electric or electronic circuitry can be operated by a software application or a firmware application executed by one or more processors; the one or more processors can be internal or external to the apparatus and can execute at least a part of the software or firmware application. In yet another example, a component can be an apparatus that provides specific functionality through electronic components without mechanical parts; the electronic components can comprise one or more processors therein to execute software and/or firmware that confer(s), at least in part, the functionality of the electronic components.

Aspects of systems, apparatus, and processes explained herein can constitute machine-executable instructions embodied within a machine, e.g., embodied in a computer readable medium (or media) associated with the machine. Such instructions, when executed by the machine, can cause the machine to perform the operations described. Additionally, the systems, processes, process blocks, etc. can be embodied within hardware, such as an application specific integrated circuit (ASIC) or the like. Moreover, the order in which some or all of the process blocks appear in each process should not be deemed limiting. Rather, it should be understood by a person of ordinary skill in the art having the benefit of the instant disclosure that some of the process blocks can be executed in a variety of orders not illustrated.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, and/or explicit data. Inference can be employed to identify a specific context or action, or can generate a probability distribution over states of interest based on a consideration of data and events, for example.

Furthermore, the word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art having the benefit of the instant disclosure.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, computer-readable carrier, or computer-readable media. For example, computer-readable media can comprise, but are not limited to: random access memory (RAM); read only memory (ROM); electrically erasable programmable read only memory (EEPROM); flash memory or other memory technology (e.g., card, stick, key drive, thumb drive, smart card); solid state drive (SSD) or other solid-state storage technology; optical disk storage (e.g., compact disk (CD) read only memory (CD ROM), digital video/versatile disk (DVD), Blu-ray disc); cloud-based (e.g., Internet based) storage; magnetic storage (e.g., magnetic cassettes, magnetic tape, magnetic disk storage or other magnetic storage devices); a virtual device/virtualized device that emulates a storage device and/or any of the above computer-readable media; or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

As it is employed in the subject specification, the term “processing component” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “data storage”, “data store”, “storage space”, “data storage device”, “storage medium”, “memory component”, and substantially any other information storage component relevant to operation and functionality of a system, component, and/or process, can refer to “memory components,” or entities embodied in a “memory,” or components comprising the memory. It will be appreciated that the memory components described herein can be either volatile memory or nonvolatile memory, or can comprise both volatile and nonvolatile memory.

By way of illustration, and not limitation, nonvolatile memory, for example, can be included in a memory component (260), non-volatile memory 1722 (see below), disk storage 1724 (see below), and/or memory storage 1746 (see below). Further, nonvolatile memory can be included in read only memory (ROM), programmable ROM (PROM), electrically programmable ROM (EPROM), electrically erasable ROM (EEPROM), or flash memory. Volatile memory (e.g., 1720) can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Additionally, the disclosed memory components of systems or methods herein are intended to comprise, without being limited to comprising, these and any other suitable types of memory.

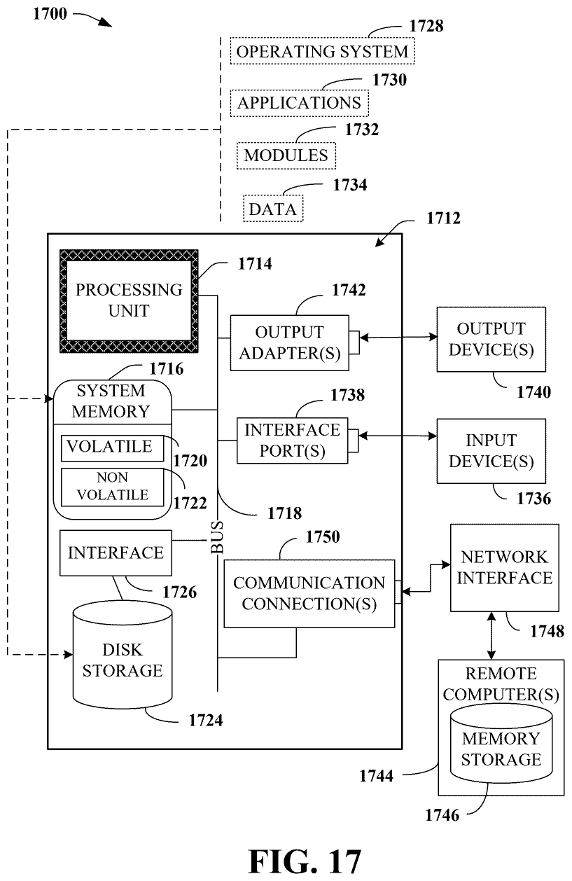

In order to provide a context for the various aspects of the disclosed subject matter, FIG. 17, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that various embodiments disclosed herein can be implemented in combination with other program modules. Generally, program modules comprise routines, programs, components, data structures, etc. that perform particular tasks and/or implement particular abstract data types.

Moreover, those skilled in the art will appreciate that the inventive systems can be practiced with other computer system configurations, comprising single-processor or multiprocessor computer systems, computing devices, mini-computing devices, mainframe computers, as well as personal computers, hand-held computing devices (e.g., PDA, phone, watch), microprocessor-based or programmable consumer or industrial electronics, and the like. The illustrated aspects can also be practiced in distributed computing environments where tasks are performed by remote processing devices that are linked through a communication network; however, some if not all aspects of the subject disclosure can be practiced on stand-alone computers. In a distributed computing environment, program modules can be located in both local and remote memory storage devices.

With reference to FIG. 17, a block diagram of a computing system 1700 operable to execute the disclosed systems and methods, e.g., via cloud computing environment and infrastructure (101), is illustrated, in accordance with an embodiment. Computer 1712 comprises a processing unit 1714, a system memory 1716, and a system bus 1718. System bus 1718 couples system components comprising, but not limited to, system memory 1716 to processing unit 1714. Processing unit 1714 can be any of various available processors. Dual microprocessors and other multiprocessor architectures can also be employed as processing unit 1714.

System bus 1718 can be any of several types of bus structure(s) comprising a memory bus or a memory controller, a peripheral bus or an external bus, and/or a local bus using any variety of available bus architectures comprising, but not limited to, industrial standard architecture (ISA), micro-channel architecture (MSA), extended ISA (EISA), intelligent drive electronics (IDE), VESA local bus (VLB), peripheral component interconnect (PCI), card bus, universal serial bus (USB), advanced graphics port (AGP), personal computer memory card international association bus (PCMCIA), Firewire (IEEE 1394), small computer systems interface (SCSI), and/or controller area network (CAN) bus used in vehicles.

System memory 1716 comprises volatile memory 1720 and nonvolatile memory 1722. A basic input/output system (BIOS), containing routines to transfer information between elements within computer 1712, such as during start-up, can be stored in nonvolatile memory 1722. By way of illustration, and not limitation, nonvolatile memory 1722 can comprise ROM, PROM, EPROM, EEPROM, or flash memory. Volatile memory 1720 comprises RAM, which acts as external cache memory. By way of illustration and not limitation, RAM is available in many forms such as SRAM, dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1712 also comprises removable/non-removable, volatile/non-volatile computer storage media. FIG. 17 illustrates, for example, disk storage 1724. Disk storage 1724 comprises, but is not limited to, devices like a magnetic disk drive, floppy disk drive, tape drive, Jaz drive, Zip drive, LS-100 drive, flash memory card, or memory stick. In addition, disk storage 1724 can comprise storage media separately or in combination with other storage media comprising, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1724 to system bus 1718, a removable or non-removable interface is typically used, such as interface 1726.

It is to be appreciated that FIG. 17 describes software that acts as an intermediary between users, e.g., subscribers, and computer resources described in suitable operating environment 1700. Such software comprises an operating system 1728. Operating system 1728, which can be stored on disk storage 1724, acts to control and allocate resources of computer system 1712. System applications 1730 take advantage of the management of resources by operating system 1728 through program modules 1732 and program data 1734 stored either in system memory 1716 or on disk storage 1724. It is to be appreciated that the disclosed subject matter can be implemented with various operating systems or combinations of operating systems.

A user, e.g., subscriber, can enter commands or information into computer 1712 through input device(s) 1736. Input devices 1736 comprise, but are not limited to, a pointing device such as a mouse, trackball, stylus, touch pad, keyboard, microphone, joystick, game pad, satellite dish, scanner, TV tuner card, digital camera, digital video camera, web camera, cellular phone, user equipment, smartphone, and the like. These and other input devices connect to processing unit 1714 through system bus 1718 via interface port(s) 1738. Interface port(s) 1738 comprise, for example, a serial port, a parallel port, a game port, a universal serial bus (USB), a wireless based port, e.g., Wi-Fi, Bluetooth, etc. Output device(s) 1740 use some of the same type of ports as input device(s) 1736.

Thus, for example, a USB port can be used to provide input to computer 1712 and to output information from computer 1712 to an output device 1740. Output adapter 1742 is provided to illustrate that there are some output devices 1740, like display devices, light projection devices, monitors, speakers, and printers, among other output devices 1740, which use special adapters. Output adapters 1742 comprise, by way of illustration and not limitation, video and sound devices, cards, etc. that provide means of connection between output device 1740 and system bus 1718. It should be noted that other devices and/or systems of devices provide both input and output capabilities such as remote computer(s) 1744.

Computer 1712 can operate in a networked environment using logical connections to one or more remote computers, such as remote computer(s) 1744. Remote computer(s) 1744 can be a personal computer, a server, a router, a network PC, a workstation, a microprocessor-based appliance, a peer device, or other common network node and the like, and typically comprises many or all of the elements described relative to computer 1712.

For purposes of brevity, only a memory storage device 1746 is illustrated with remote computer(s) 1744. Remote computer(s) 1744 is logically connected to computer 1712 through a network interface 1748 and then physically and/or wirelessly connected via communication connection 1750. Network interface 1748 encompasses wire and/or wireless communication networks such as local-area networks (LAN) and wide-area networks (WAN). LAN technologies comprise fiber distributed data interface (FDDI), copper distributed data interface (CDDI), Ethernet, token ring and the like. WAN technologies comprise, but are not limited to, point-to-point links, circuit switching networks like integrated services digital networks (ISDN) and variations thereon, packet switching networks, and digital subscriber lines (DSL).

Communication connection(s) 1750 refer(s) to hardware/software employed to connect network interface 1748 to bus 1718. While communication connection 1750 is shown for illustrative clarity inside computer 1712, it can also be external to computer 1712. The hardware/software for connection to network interface 1748 can comprise, for example, internal and external technologies such as modems, comprising regular telephone grade modems, cable modems and DSL modems, wireless modems, ISDN adapters, and Ethernet cards.

The computer 1712 can operate in a networked environment using logical connections via wired and/or wireless communications to one or more remote computers, cellular based devices, user equipment, smartphones, or other computing devices, such as workstations, server computers, routers, personal computers, portable computers, microprocessor-based entertainment appliances, peer devices or other common network nodes, etc. The computer 1712 can connect to other devices/networks by way of antenna, port, network interface adaptor, wireless access point, modem, and/or the like.

The computer 1712 is operable to communicate with any wireless devices or entities operatively disposed in wireless communication, e.g., a printer, scanner, desktop and/or portable computer, portable data assistant, communications satellite, user equipment, cellular base device, smartphone, any piece of equipment or location associated with a wirelessly detectable tag (e.g., scanner, a kiosk, news stand, restroom), and telephone. This comprises at least Wi-Fi and Bluetooth wireless technologies. Thus, the communication can be a predefined structure as with a conventional network or simply an ad hoc communication between at least two devices.

Wi-Fi allows connection to the Internet from a desired location (e.g., a vehicle, couch at home, a bed in a hotel room, or a conference room at work, etc.) without wires. Wi-Fi is a wireless technology similar to that used in a cell phone that enables such devices, e.g., mobile phones, computers, etc., to send and receive data indoors and out, anywhere within the range of a base station. Wi-Fi networks use radio technologies called IEEE 802.11 (a, b, g, etc.) to provide secure, reliable, fast wireless connectivity. A Wi-Fi network can be used to connect communication devices (e.g., mobile phones, computers, etc.) to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a processor; and
a memory that stores executable components that, when executed by the processor, facilitate performance of operations by the system, the operations comprising:
sending, via a client interface, default survey questions directed to a client, wherein the default survey questions are directed to assess current capabilities of respective functions of a group of functions corresponding to a cloud computing environment and infrastructure of the client;
receiving, via the client interface, respective default survey responses to the default survey questions;
based on the respective default survey responses, assigning, via a data store, a capability level of a group of capability levels to each function of the group of functions;
converting a group of assigned capability levels that have been assigned to the group of functions into a distinct capability signature that numerically represents a derived capability profile of the group of functions, wherein the group of assigned capability levels comprises the capability level; and
based on the derived capability profile, predicting, using a machine learning process, follow-up survey questions that are directed to further assess
additional functional capabilities of the group of functions, or
alternate functional capabilities of a different group of functions that is different from the group of functions.

2. The system of claim 1, wherein the assigning of the capability level to each function comprises:
determining a sum of respective scores of a group of responses corresponding to a group of survey questions of the default survey questions that have been directed to assess capabilities of a function of the group of functions; and
based on the sum being determined to correspond to the capability level, assigning the capability level to the function.

3. The system of claim 2, wherein the group of capability levels comprises a triad of distinct capability levels, and wherein each distinct capability level of the triad of distinct capability levels corresponds to a defined range of the sum of the respective scores of the group of responses.

4. The system of claim 1, wherein the converting of the group of assigned capability levels into the distinct capability signature comprises:
based on a number of functions that have been included in the group of functions, generating the distinct capability signature, wherein the distinct capability signature comprises a defined number of digits of a defined mathematical radix, and wherein the defined number of digits has been selected to equal the number of functions that have been included in the group of functions.

5. The system of claim 1, wherein the converting of the group of assigned capability levels into the distinct capability signature comprises:
based on historical training data comprising responses to a defined amount of survey questions that have been directed to assess respective capabilities of the cloud computing environment and infrastructure, associating, via the data store, the distinct capability signature with the derived capability profile, wherein the derived capability profile represents a capability profile that requires information about the additional functional capabilities of the group of functions or the alternate functional capabilities of the different group of functions.

6. The system of claim 5, wherein the predicting of the follow-up survey questions comprises:
based on the distinct capability signature, selecting, using the data store, the derived capability profile; and
based on the derived capability profile, selecting the follow-up survey questions.

7. The system of claim 1, wherein the distinct capability signature is a first distinct capability signature, and wherein the operations further comprise:
sending, via the client interface, the follow-up survey questions directed to the client;
receiving, via the client interface, respective follow-up survey responses to the follow-up survey questions;
based on the respective follow-up survey responses and the first distinct capability signature, generating a second distinct capability signature that numerically represents an updated derived capability profile of at least one of the group of functions or the different group of functions;
based on the updated derived capability profile, generating a summarized output comprising at least one of a determined capability of the group of functions,
a determined capability of the different group of functions,
a determined risk impeding a performance of the group of functions,
a determined risk impeding a performance of the different group of functions, or
a suggested change corresponding to the cloud computing environment and infrastructure to facilitate an optimization of the group of functions or the different group of functions; and
sending, via the client interface, the summarized output directed to the client.

8. The system of claim 7, wherein the generating of the second distinct capability signature comprises:
associating, via the data store, the second distinct capability signature with the updated derived capability profile, wherein the updated derived capability profile specifies the summarized output.

9. The system of claim 8, wherein the generating of the summarized output comprises:
based on the second distinct capability signature, selecting, using the data store, the updated derived capability profile; and
based on the updated derived capability profile, selecting the summarized output.

10. The system of claim 1, wherein the derived capability profile and the updated derived capability profile represent at least one of a performance capability profile, a reliability capability profile, a data security capability profile, a cost management capability profile, an organizational capability profile, or an operational sustainability capability profile.

11. The system of claim 10, wherein the group of functions comprises an array of functional capabilities corresponding to an operation of the cloud computing environment, a security of the cloud computing environment, and a performance optimization of the cloud computing environment, and wherein the functional capabilities comprise data management functions, data security functions, resource allocation functions, and service continuity functions.

12. The system of claim 1, wherein the cloud computing environment and infrastructure comprises at least one of a storage network, a computing network, a cloud-based network, a cloud computing environment, a data center, or an on-premises-based network.

13. A method, comprising:
sending, by a system comprising at least one processor via a customer interface, initial survey questions that are directed to assess present capabilities of a group of functions corresponding to operation of a cloud computing environment and infrastructure;
based on respective initial survey responses to the initial survey questions that have been received via the customer interface, assigning, by the system, a distinct capability level of a defined number of distinct capability levels to each function of the group of functions;
converting, by the system, a group of distinct capability levels that have been assigned to the group of functions into a distinct signature comprising a defined numerical base, wherein the distinct signature represents a derived capability profile representing functional capabilities of the group of functions, and wherein the group of distinct capability levels comprises the distinct capability level; and
based on the derived capability profile, predicting, by the system via a machine learning process, follow-up survey questions that are directed to further assess the functional capabilities of the group of functions or other functional capabilities that are different from the functional capabilities of the group of functions.

14. The method of claim 13, wherein the assigning of the distinct capability level comprises:
quantifying a sum of scores of a group of responses of the respective initial survey responses corresponding to a function of the group of functions into the distinct capability level.

15. The method of claim 14, wherein the defined number of distinct capability levels is three, and wherein the converting of the group of distinct capability levels that have been assigned to the group of functions comprises:
transforming the group of distinct capability levels into a trinary signature representing the derived capability profile, wherein the trinary signature comprises a number of digits that are equal to a number of functions that have been included in the group of functions, and wherein the derived capability profile expects further information about the functional capabilities of the group of functions or the other functional capabilities that are different from the respective functional capabilities of the group of functions.

16. The method of claim 13, wherein the predicting comprises:
based on historical training data comprising responses to a defined number of survey questions that have been directed to assess respective capabilities of the cloud computing environment and infrastructure, associating, utilizing a machine learning process via a data store, respective distinct signatures comprising the distinct signature to respective survey questions of the follow-up survey questions.

17. The method of claim 13, further comprising:
in response to sending the follow-up survey questions directed to a customer via the customer interface, receiving, by the system via the customer interface, respective follow-up survey responses to the follow-up survey questions;
based on the respective follow-up survey responses, generating, by the system, a modified distinct signature that is different from the distinct signature and that represents an updated derived capability profile representing at least one of the functional capabilities of the group of functions or the other functional capabilities that are different from the functional capabilities of the group of functions;
based on the updated derived capability profile, generating, by the system, a summarized output that identifies at least one of
a capability of the cloud computing environment and infrastructure,
a determined risk impeding a performance of the cloud computing environment and infrastructure, or
a suggested change corresponding to the cloud computing environment and infrastructure to facilitate an optimization the cloud computing environment and infrastructure; and
sending, by the system via the customer interface, the summarized output directed to the customer.

18. The method of claim 17, wherein respective portions of at least one of the initial survey questions or the follow-up survey questions comprise respective free-form text fields, and wherein at least one of the generating of the distinct signature or the generating of the modified distinct signature comprises:
converting, utilizing natural language processing via a machine learning process, the respective free-form text fields into a text output comprising respective keywords representing content of the free-form text fields; and
based on the text output and the respective keywords, generating at least one of the distinct signature or the modified distinct signature.

19. A non-transitory machine-readable medium comprising instructions that, in response to execution, cause a system comprising at least one processor to perform operations, the operations comprising:
in response to sending default survey questions directed to a user device for assessment of current capabilities of respective functions of a group of functions corresponding to a cloud computing environment and infrastructure of the user device, receiving respective default survey responses to the default survey questions; and
based on the respective default survey responses,
assigning a capability level of a group of capability levels to each function of the group of functions,
converting a group of assigned capability levels, comprising the capability level, that have been assigned to the group of functions into a distinct signature that represents a derived capability profile of the group of functions, and
based on the derived capability profile, predicting, via a machine learning process, follow-up survey questions that are directed to further assess additional functional capabilities of the group of functions or alternate functional capabilities of a different group of functions that is different from the group of functions.

20. The non-transitory machine-readable medium of claim 19, wherein the distinct signature is a first distinct signature, and wherein the operations further comprise:
in response to sending the follow-up survey questions directed to the user device, receiving respective follow-up survey responses to the follow-up survey questions;
based on the respective follow-up survey responses,
generating a second distinct signature that numerically represents an updated derived capability profile of at least one of the group of functions or the different group of functions,
based on the updated derived capability profile, generating an output comprising a summary of at least one of
a capability of the cloud computing environment and infrastructure,
a determined risk impeding a performance of the cloud computing environment and infrastructure, or
a suggested change corresponding to the cloud computing environment and infrastructure to facilitate an optimization the cloud computing environment and infrastructure; and
sending the output directed to the user device.
